(19) United States
(12) Patent Application Publication
(10) Pub. No.: US 2026/0220105 A1
(43) Pub. Date: Jul. 30, 2026

(54) STORAGE SYSTEM AND STORAGE SYSTEM CONTROL METHOD

(71) Applicant: Hitachi Vantara, Ltd., Yokohama-shi (JP)

(72) Inventor: Chenqi ZHU, Yokohama-shi (JP)

(21) Appl. No.: 19/309,922

(22) Filed: Aug. 26, 2025

(30) Foreign Application Priority Data
Jan. 29, 2025 (JP) 2025-013386

(51) Int. Cl. G06F 16/21

(52) U.S. Cl. CPC G06F 16/217

(57) ABSTRACT

A storage system controls the performance of a logical volume to satisfy the performance set for the logical volume and logical volume group. The storage system includes logical volumes and logical volume groups each containing at least one of the logical volumes. The storage system stores QoS settings, which are the required performance values for the logical volumes or volume groups, an adjustment range judgment section determining the adjustment range of the logical volume from the range logical volume in the logical volume group or logical volume in the entire system when the QoS settings of the logical volume or logical volume group are not satisfied, and a performance control section judging whether the performance setting value for the logical volume in the adjustment range is satisfied and adjusting the processing speed of input/output requests to the logical volume in the adjustment range based on the judgment result.

### CROSS-REFERENCE TO RELATED APPLICATION

The present application claims priority from Japanese application JP 2025-013386, filed on Jan. 29, 2025, the content of which is hereby incorporated by reference into this application.

### TECHNICAL FIELD

This invention relates to a storage system and storage system control method.

### BACKGROUND ART

In a storage environment where multiple logical volumes or logical volume groups coexist, it is desired to comprehensively manage the performance of each logical volume and provide appropriate performance (QoS: Quality of Service) in enterprise-level data centers, cloud storage services, virtualization environments, and high-performance computing.

In addition, the development of AI technologies has made data processing and analysis faster and more complex, increasing the need to process large amounts of data at high speeds and provide the performance required for specific applications and services. Especially in enterprise-level data centers and cloud environments, where multiple clients and applications with different service level requirements coexist, flexible and advanced QoS control methods are required.

And the performance of storage provided to clients and applications is defined by SLA (Service Level Agreement) and other agreements that specify IOPS (Input Output Per Second), data transfer amount, etc.

Furthermore, the performance that can be provided to a logical volume or logical volume group is also limited depending on the performance of the hardware used, such as HDD (Hard Disk Drive), SSD (Solid State Drive), etc.

This may make it difficult to make simple adjustments such as lowering the performance of other logical volumes when performance shortfalls occur in a particular logical volume.

In the storage system management system of patent document 1, in order to realize the QoS function in units of virtual volume groups spanning multiple storage devices, multiple volumes provided by multiple storage devices are used, the virtual volume group is formed using multiple volumes provided by multiple storage devices, the QoS setting values including the amount of data input/output are set for the virtual volume group, the IO processing capacity provided by each volume to the virtual volume group is set to satisfy the QoS setting values, and the management system is configured to provide IO processing capacity to each volume based on the operating information of each volume.

To adjust the performance among volumes, the patent document 2 discloses setting target values for the performance of data transmission and reception for multiple volumes, storing information on the difference between the measured performance of data transmission and reception for the volumes and the target values in the performance exceedance table, and if the target value is not achieved, the bandwidth management unit calculates the difference between the measured value of performance and the target value for the given volume, and based on the information of the calculated difference and the information of the difference between the measured value of performance and the target value stored in the performance exceedance value table, selects an exclusion target among the volumes and bandwidth allocation adjusts by excluding the target value of the volume to be excluded.

### CITATION LIST

### Patent Document

[Patent documents1] Japanese unexamined patent publication Tokkai2023-34491
[Patent documents2] Japanese unexamined patent publication Tokkai2020-35207

### SUMMARY OF THE INVENTION

### Problems to be Solved by the Invention

However, the techniques described in all these documents only disclose control methods when the logical volume or logical volume group has a QoS setting.

When QoS settings are set for a logical volume group and QoS settings are also set for the logical volumes included in the logical volume group, It is not disclosed that performance adjusting is performed on logical volumes within a logical volume group, and if performance adjusting cannot be performed within a logical volume group, performance adjusting is performed on the storage system as a whole.

In recent years, business models in the storage market have been changing, and service-side business models such as STaaS (Storage as a Service) and PaaS (Platform as a Service) have become popular. The shift to a form in which storage service providers act as intermediaries and provide resources to end users on a pay-as-you-go basis is progressing. With this change, the following needs have arisen.

### Storage Servicer Needs (SLA Per Group)

Total Quality of Service Management: Because storage servicers need to provide consistent and reliable service to multiple tenants (end users), effective control throughout the QoS group, which consists of logical volume groups is essential.

It is required to utilize resources without excess or deficiency by creating groups and allocating overall resources to each group according to the requirements of each tenant (end users)

Efficient resource utilization: To manage storage devices where multiple tenants (end users) coexist, shared resources must be dynamically distributed based on priority to optimize overall efficiency. This allows the servicer to meet end user needs while maximizing resource utilization.

### End User Needs (SLA Per Volume)

Application specific control: End users need to make their own adjustments according to the characteristics of each application within the resources given by the storage servicer. This requires individual QoS control for specific volumes, and there is a need to achieve efficient resource allocation.

Own QoS settings: Even in the position of borrowing resources, it is desirable for end users to be able to adjust the usage and allocation of resources independently according to specific applications or projects.

Against this background, there is a need for “composite QoS control” that satisfies the needs of both storage servicers and end users. In conventional technologies, QoS control is mainly performed on a per group basis for multiple LDEV, where individual LDEV settings are not possible. This made flexible resource allocation tailored to specific end service agreements (SLA) difficult. Composite QoS control allows individual control of each volume while maintaining group management as a whole.

The present invention was made in view of the above mentioned problems. One of the purposes of the present invention is to satisfy the performance set for the logical volume (hereinafter sometimes described as “LDEV”) and logical volume group (hereinafter sometimes described as “QoS group”) of the storage system.

### Solutions to Problems

The above problem is solved by a storage system including a plurality of logical volumes and one or more logical volume groups each containing at least one of the pluralities of logical volumes comprising, a memory storing QoS settings, which are the required performance values for the logical volumes or logical volume groups, an adjustment range judgment section determining the adjustment range of the logical volume from the range logical volume in the logical volume group or logical volume in the entire system when the performance setting value of the logical volume is not satisfied or the QoS settings of the logical volume group is not satisfied, and a performance control section judging whether the QoS settings for the logical volume in the adjustment range is satisfied and adjusting the processing speed of input/output requests to the logical volume in the adjustment range based on the judgment result.

### Effects of the Intervention

The performance of a logical volume can be controlled to meet the performance set for the logical volume and logical volume group of the storage system.

### BRIEF DESCRIPTION OF THE DRAWINGS

FIG. 1 Example of a storage device configuration diagram.

FIG. 2 Example of a hardware configuration diagram in the embodiment.

FIG. 3 Example of a System configuration diagram in the embodiment.

FIG. 4 Example of an LDEV configuration information table in the embodiment.

FIG. 5 Example of a QoS group configuration information table in the embodiment.

FIG. 6 Example of an LDEV operation information table in the embodiment.

FIG. 7 Example of a QoS group operation information table in the embodiment.

FIG. 8 Example of a LDEV's achievement table in the embodiment.

FIG. 9 Example of a QoS group's achievement table in the embodiment.

FIG. 10 Example of an IO queue retention time table in the embodiment.

FIG. 11 Example of an LDEV maximum performance estimation in the embodiment.

FIG. 12 Example of a maximum performance estimation of QoS group in the embodiment.

FIG. 13 Example of an LDEV unit setting screen in the embodiment.

FIG. 14 Example of a per QoS group setting screen in the embodiment.

FIG. 15 Example of a flowchart showing a control method of the storage system in the embodiment.

FIG. 16 Example of a flowchart of an LDEV achievement status judgment process in the embodiment.

FIG. 17 Example of a flowchart of a QoS group achievement status determination process in the embodiment.

FIG. 18 Example of a flowchart of an LDEV performance adjustment target judgment process in the embodiment.

FIG. 19 Example of a flowchart of a decision making process of whether to adjust the performance in a QoS group in the embodiment.

FIG. 20 Example of a flowchart of a performance adjustment process in the embodiment.

FIG. 21 Example of a flowchart of a QoS group performance adjustment process in the embodiment.

FIG. 22 Example of a flowchart of an LDEV performance adjustment process in the embodiment.

### MODE FOR CARRYING OUT THE INVENTION

The following embodiments of the invention are explained using the drawings. In each figure to explain the embodiment, the same name and code will be used for the same components as much as possible, and repeated explanations will be omitted.

The present invention is not limited to the embodiments described below but includes various variations and equivalent configurations within the scope of the appended claims. For example, the embodiments are described in detail for the sake of clarity, and the invention is not necessarily limited to those having all the configurations described.

The processing sections and processing modules described in the embodiments may be realized in hardware by designing some or all of them in an integrated circuit, for example, or in software by having a processor interpret and execute a program to realize the respective functions.

The information described in the embodiments may be tables, databases (DB), or data stored in main memory.

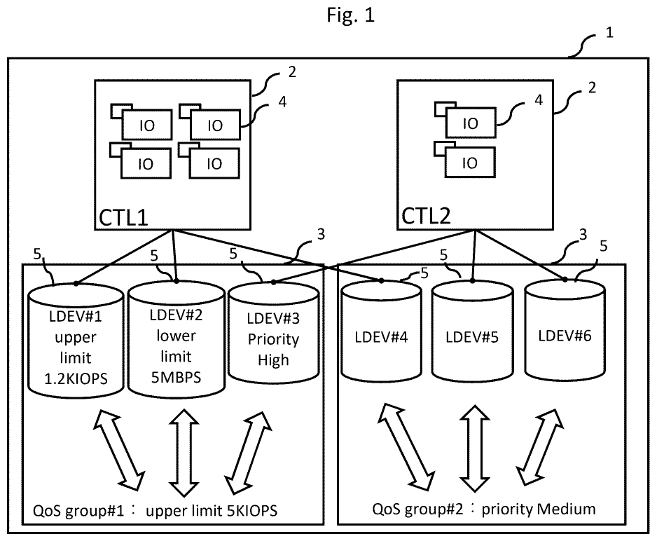

FIG. 1 shows an example of the configuration diagram of a storage device in the embodiment.

Storage device 1 comprises a plurality of controllers (CTLs) 2 and a plurality of LDEVs 5 (logical volumes) connected to each controller 2. Controller 2 has a processor that processes IO queue 4.

Of the multiple LDEV 5, LDEV #1 has an upper limit of 1.2 KIOPS, which is the number of IOPS per unit time, based on the performance requirements of the application from the end user side.

Similarly, LDEV #2 has a lower limit of 5 MBPS, which is the amount of data transferred per unit time, and LDEV #3 has a priority of high as the response target value.

In addition, QoS group #1, which consists of LDEV #1-LDEV #3, has an upper limit of 5 KIOPS for IOPS as the sum of the performance of LDEV #1-LDEV #3 based on SLA at the storage service side.

As shown in FIG. 1, if QoS group #1 consisting of LDEV #1- #3 has an upper IOPS limit of 5 KIOPS and LDEV #2 has a lower IOPS limit of 5 MBPS, in the case where the transfer length from the host is 2 KB, QoS group #1's upper throughput limit would be 5 KIOPS×2 KB=10 MBPS. If 3.3 MBPS is allocated equally to LDEV #1-#3, the lower limit of 5 MBPS set for LDEV #2 would not be met.

In this case, if 5 MBPS can be allocated to LDEV #2, 2.4 MBPS(=1.2 KIOPS) to LDEV #1, and 2.6 MBPS to LDEV #3, this problem can be solved and unused performance in QoS group #1 can be effectively used.

In storage device 1, priority: Medium is set in QoS group #2, which consists of LDEVs #4-#6, separately from QoS group #1. If all 30 KIOPS are allocated to QoS group #2 in advance to meet the response target of 5 ms corresponding to the medium priority set for QoS group #2, it is difficult to meet the lower limit of LDEV #2 in QoS group #1.

Therefore, it is possible to assign the lower limit of 5 KIOPS to LDEV #1 in QoS group #1 by assigning the surplus performance of LDEVs that do not belong to QoS group #1, QoS group #2, and QoS group in storage device 1 to LDEV #2, this allows for effective use of unused performance in the storage device.

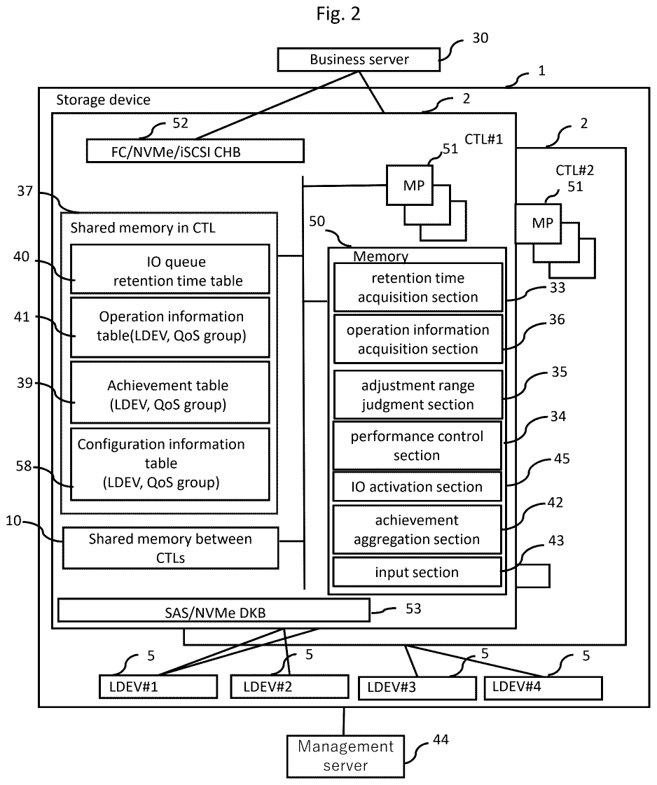

FIG. 2 shows an example of the hardware configuration diagram in the embodiment.

Storage device 1 is coupled with the user's business server 30 via FC/NVMe/iSCSI CHB52 and provides storage services to the business server 30 that serves the tenant (end user). In addition, management server 44 is coupled with storage device 1, and monitors, configures, and monitors failures of the storage device.

The controller 2 is equipped with one or more controllers 2 (sometimes referred to as CTL), and the controller 2 contains MP (Micro Processor) 51, memory 50 that stores each processing module that processes the storage device, and shared memory in CTL 37 that stores LDEV and tables that manage the status of QoS group (logical volume group) etc. and shared memory between CTLs 10 that shares information among controllers.

The shared memory in CTL 37 is suitable for managing LDEV and QoS group status in real time because it is accessible at high speed. On the other hand, shared memory between CTLs 10 is slower than shared memory in CTL 37, so it stores some of the information stored in shared memory in CTL37 that needs to be shared among the CTLs. Shared memory in CTL 37 and shared memory between CTLs 10 constitute the shared memory section.

The processing modules stored in memory 50 are retention time acquisition section 33 that calculates the time waiting in the IO queue for IO processing requests made to LDEV, operation information acquisition section 36 that calculates the number of I/Os executed by LDEV and QoS groups, the amount of data transferred, the average response, etc., adjustment range judgment section 35 determines the range in which the performance of LDEVs and QoS groups can be adjusted based on the retention time in the queue, and the adjustment range of each LDEV is determined by the number of IO requests to each LDEV, performance control section 34 that adjusts performance by changing the time interval at which IO processing requests are executed for each LDEV, and

IO activation section 45 that activates IO requests registered in IO queue for each LDEV at intervals specified in the performance control section, achievement aggregation section 42 that determines the degree to which the performance requirements set for LDEVs and QoS groups are met, and input section 43 that accepts input such as configuration information from the management server 44.

The shared memory in CTL 37 contains IO queue retention time table 40, operation information table 41 for each LDEV and QoS group, an acknowledgement, achievement tables 39 for each LDEV and QoS group, configuration information table 58 that stores the required performance set for each LDEV and QoS group is stored in CTL 37. In addition, in shared memory in CTL 37, IO queue 4 (not shown) is reserved for each LDEV as an area to temporarily reserve data input/output request instructions from tenants.

The processing modules implemented in software stored in memory 50 refer to the information in the table stored in shared memory in CTL 37 and are executed by MP 51. The processing module may be implemented in hardware, such as an application specific integrated circuit (ASIC).

Each controller 2 is connected to LDEV 5 to control LDEV and QoS group.

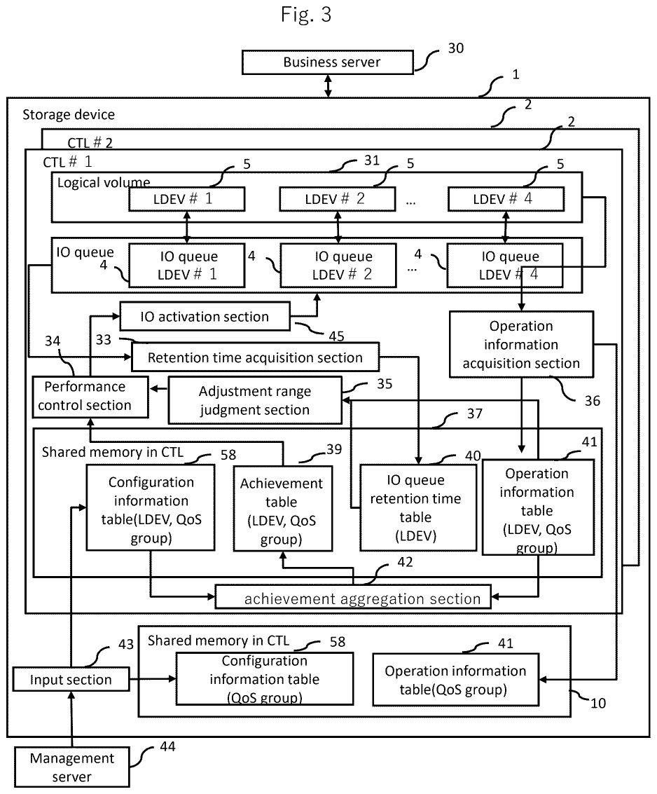

FIG. 3 shows an example of the system configuration diagram in the embodiment.

The retention time acquisition section 33 monitors the IO queue 4 provided for each LDEV 5, obtains the retention time of the input/output processing request for the corresponding LDEV 5, and writes it into the IO queue retention time table 40.

The operation information acquisition section 36 obtains operation information from each LDEV 5 and writes the operation information of the LDEV and QoS group to the operation information table 41. The operation information table 41 is located in shared memory in CTL 37, and a copy of the operation information of the QoS group is also stored in shared memory between CTLs 10, and is referred to between CTLs.

The adjustment range judgment section 35 refers to the IO queue retention time table 40 and the operation information table 41, the LDEV performance adjustment target determination process or the QoS group achievement status determination process described below determines the range which LDEV performance can be adjusted.

The IO activation section 45 provides instructions to execute input/output requests from the business server 30 that are registered sequentially in IO queue 4 for each LDEV 5. This instruction is called IO queue processing, and IO activation section 45 gives this instruction at a fixed time interval. It is possible to adjust the processing speed of LDEV IO requests by changing the predefined time interval.

Therefore, if there is a backlog of IO requests in IO queue 4, i.e., IO requests waiting to be executed, it is possible to shorten the time interval of IO queue processing to increase IO requests to LDEV 5 and increase the processing speed of LDEV 5, but if there is no backlog in IO queue, it is not possible to shorten the time interval of processing to IO queue any more.

If the adjustment range judgment section 35 determines that adjustment is possible, the performance control section 34 changes the time interval of IO queue processing for the LDEV. The IO activation section 45 activates the execution of input/output requests registered in IO queue 4 for each LDEV 5 at time intervals modified by the performance control section 34.

The achievement aggregation section 42 calculates the achievement level of each LDEV 5 with reference to the configuration information table 58 and the operation information table 41 and writes it to the achievement table 39.

The input section 43 receives the upper and lower performance limits and priorities of LDEVs and QoS groups from the management server 44 and writes them into the configuration information table 58 for shared memory in CTL 37 and shared memory between CTLs 10.

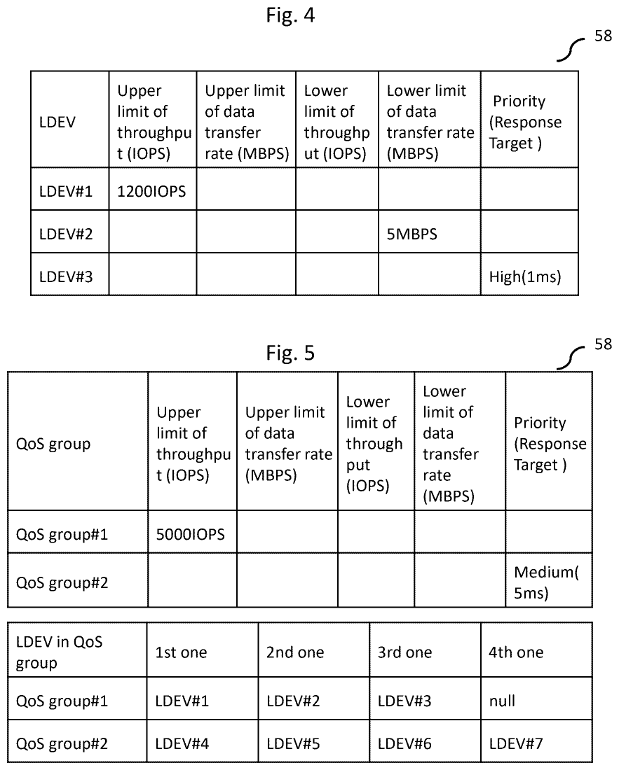

FIG. 4 shows an example of the configuration information table of LDEVs in the embodiment. The configuration information table 58 of LDEV 5 sets the upper and lower limits of the number of IOs, the upper and lower limits of the amount of data transfer, and the priority of LDEVs as the required performance values for each LDEV based on SLA. The priority is a target value for response and is set to 1 ms for “high”, 5 ms for “medium”, 10 ms for “low” and so on.

These values are set by the user based on the SLA. These values do not necessarily have to be set, and LDEVs with none of these values set are not subject to performance adjustment.

FIG. 5 shows an example of QoS group configuration information table in the embodiment. The QoS group configuration information table 58 stores the upper and lower limits of the number of IOs as required performance values for each QoS group based on SLA. The priority is a target value for response, and is set to 1 ms for “high”, 5 ms for “medium” and 10 ms for “low”.

These values are set by the storage servicer based on SLA, but do not necessarily have to be set, and LDEVs with none of these values set are not subject to performance adjustment.

The QoS group configuration information table contains the identifiers of the LDEVs included in the QoS group, and the correspondence between the QoS group and the LDEVs is set.

The required performance values in FIG. 4 and FIG. 5 correspond to the required performance values for each LDEV 5 and QoS group shown in FIG. 1. Hereafter, the various required performance values set for an LDEV or QoS group are referred to as QoS settings.

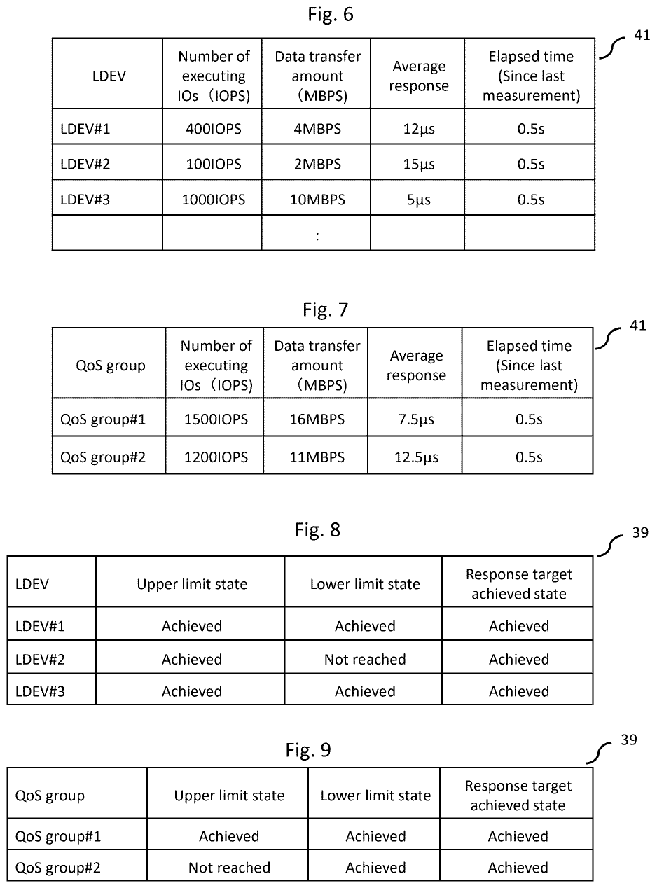

FIG. 6 shows an example of the LDEV operation information table in the embodiment. The LDEV operation information table 41 contains for each LDEV the number of IOs executed, the amount of data transferred, the average response, and the elapsed time since the last measurement.

FIG. 7 shows an example of the operation information table for a QoS group in the embodiment. The operation information table 41 for a QoS group contains for each QoS group the number of IOs executed, the amount of data transferred, the average response, and the elapsed time since the last measurement.

FIG. 8 shows an example of LDEV's achievement table in the embodiment. The LDEV's achievement table 39 contains information that indicates whether the upper and lower limits, etc., set in the LDEV configuration information table 58 have been achieved.

FIG. 9 shows an example of the QoS group achievement table in the embodiment. The QoS group achievement table 39 contains information that indicates whether the upper and lower limits, etc. set in the configuration information table 58 have been achieved.

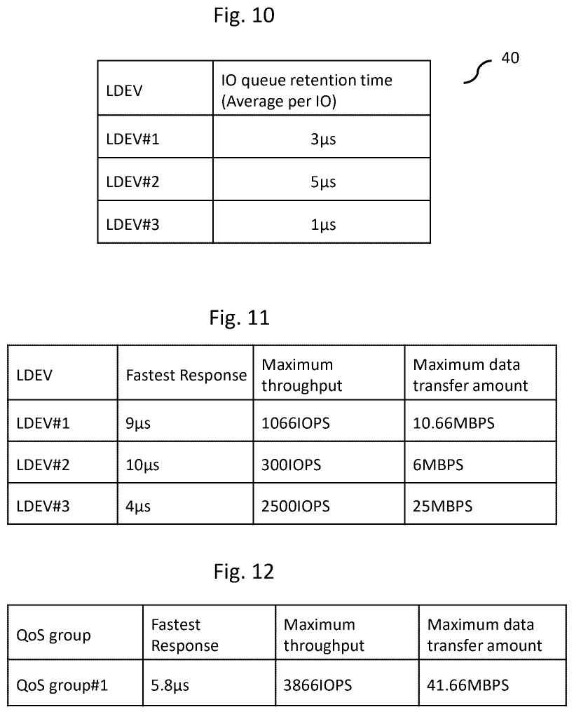

FIG. 10 shows an example of an IO queue retention time table in the embodiment. The IO queue retention time table 40 stores the IO queue retention time (average retention time for one IO) for each LDEV.

FIG. 11 shows an example of the LDEV maximum performance estimation in the embodiment. The LDEV maximum performance estimation result 100 is the maximum performance of the LDEVs expected based on the queue retention time for each LDEV.

The IO queue retention time table 40 contains the average retention time for each LDEV, so the maximum performance of LDEV #1 is estimated by assuming that the average retention time of LDEV #1 is 3 μs, the fastest response would be 9 μs, which is calculated by subtracting 3 μs from the 12 μs response time (see LDEV's operation information table in FIG. 6).

Since 400 IOPS for the number of IOs executed and the elapsed time is 0.5 s (see LDEV's operation information table in FIG. 6), the maximum throughput is (400 IOPS/0.5 s×12 μs)÷9 μs=1066 IOPS.

Also, since data transfer rate is 4 MBPS (see LDEV's operation information table in FIG. 6), the maximum data transfer rate is 1066 IOPS×(4M÷400 IOPS)=10.66 MBPS.

FIG. 12 shows an example of the QoS group maximum performance estimation in the embodiment. The QoS group maximum performance estimate result is the maximum LDEV performance expected based on the IO queue retention time for each QoS group.

The maximum performance of a QoS group is the sum of the performance of the LDEVs in the QoS group. Therefore, the fastest response for QoS group #1 is (9 μs*1066 IOPS+10 μs*300 IOPS+4 μs*2500 IOPS)/(1066 IOPS+300 IOPS+2500 IOPS)=5.8 μs.

The maximum throughput will be 1066 IOPS+300 IOPS+2500 IOPS=3866 IOPS.

The maximum data transfer rate will be 10.66 MBPS+6 MBPS+25 MBPS=41.66 MBPS.

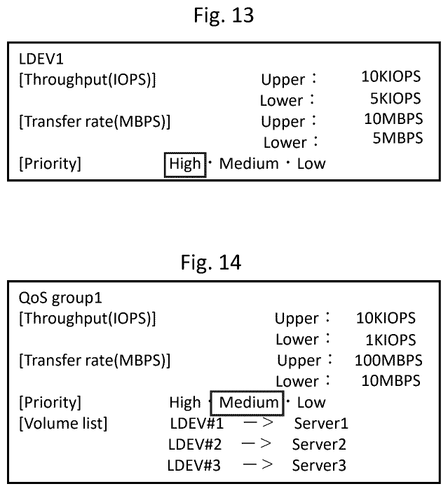

FIG. 13 shows an example of the LDEV unit setting screen in the embodiment. This screen is displayed by the tenant receiving the storage service in the input section 43, and the tenant can set the number of inputs/outputs, the upper and lower limits of the transfer rate, and the QoS settings of the priority level in LDEV units through this screen.

The tenant accesses the management server 44 via the network and sets the QoS settings.

The management server 44 updates the QoS settings of the configuration information table 58 via the input section 43.

FIG. 14 shows an example of the configuration screen for each QoS group in the embodiment. This screen is displayed on the servicer side that provides the storage service according to the input section 43, and the servicer can set the upper and lower limits of the number of inputs/outputs and transfer rate, as well as the QoS settings of priority in units of QoS groups through this screen. In addition, a volume list indicating which LDEVs comprise the QoS group is displayed, so the servicer can know which LDEVs are affected.

Furthermore, the correspondence between the LDEVs and the business servers to which they are connected is displayed, so that it is possible to know which services of the tenants are affected.

The servicer accesses the management server 44 via the network and sets the QoS settings. The management server 44 updates the configuration information table 58 of shared memory between CTLs 10 and shared memory in CTL 37 to the QoS settings via input section 43.

The same screen can be used to reference the QoS settings set in configuration information table 58, but when referencing, the values in configuration the management server 44 outputs the values of the configuration information table 58 stored in the shared memory between CTLs 10.

By accessing the configuration information table 58 in this way, the configured values can be reflected in the storage device more quickly, and references to the configured values can be referenced with less impact on the processing of the storage device.

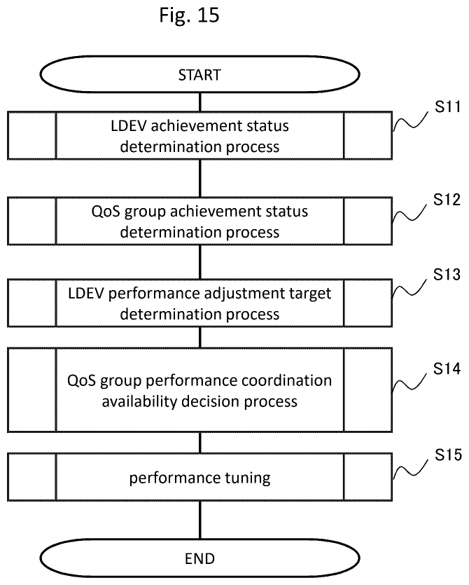

FIG. 15 is an example of a flowchart showing the control method of the storage system in the embodiment. First, the LDEV achievement status determination process is performed (S11), in which the achievement aggregation section 42 determines the achievement status of the target value for each LDEV. Next, the achievement aggregation section 42 performs the QoS group achievement status determination process for each QoS group. (S12).

Next, based on the achievement status of the target value for LDEV 5, the adjustment range judgment section 35 determines the possibility of LDEV performance adjustment for each LDEV 5 (S13). In addition, for each QoS group, the QoS group performance adjustment possibility/failure judgment process is performed, which determines the possibility of performance adjustment within the QoS group (S14).

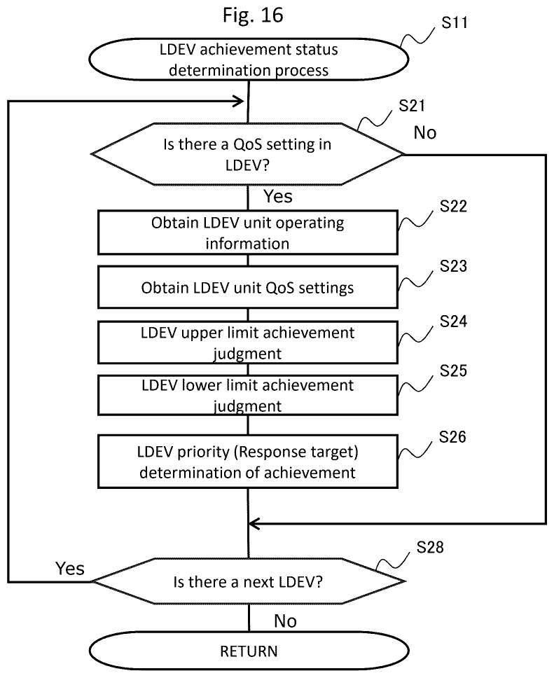

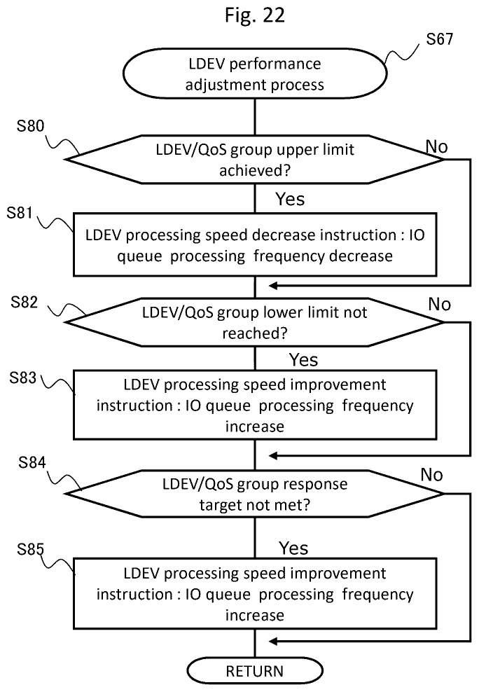

Finally, the performance control section 34 executes the performance adjustment process within the adjustment range determined to be adjustable (S15). The details of each process are described below using FIG. 16~FIG. 22.

FIG. 16 is an example of the flowchart of the LDEV achievement status determination process S11 in the embodiment. First, the achievement aggregation section 42 refers to the configuration information table 58 to determine whether the LDEV to be judged has a QoS settings for each LDEV (S21).

If there is a setting, it obtains the operating information for each LDEV from operation information table 41 (S22), obtains the QoS settings for each LDEV from configuration information table 58 (S23), determines the upper limit achievement for the LDEV (S24), determine the achievement level of the lower limit of LDEV (S25), determine the achievement level of the target value of response based on the priority of LDEV, and store the result of the determination in the achievement table 39 (S26).

When the judgment in S26 is completed or when there were no QoS settings for each LDEV in S21, it is determined whether there are any LDEVs for which judgment has not yet been processed (S28), and if so, the process from step S21 is repeated for all LDEVs.

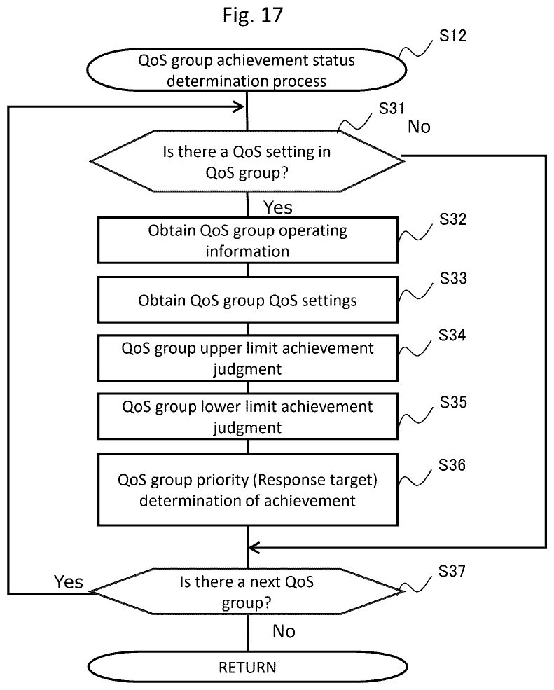

FIG. 17 shows an example flowchart of S12, the QoS group achievement status determination process in the embodiment. First, the achievement aggregation section 42 refers to the configuration information table 58 to determine whether the QoS group to be judged has a QoS group QoS settings (S31).

If there is a setting, the operation information for each QoS group is obtained from the operation information table 41 (S32), the QoS settings for each QoS group is obtained from the configuration information table 58 (S33), and the upper limit achievement level of the QoS group is determined (S34). the lower limit achievement level of the QoS group is determined (S35), the achievement level of the target response value based on the priority of the QoS group is determined, and the determination results are stored in the achievement table 39 (S36).

If the judgment in S36 is completed, or if the QoS group in question does not have a performance setting value for each QoS group in S31, it determines whether there are any QoS groups for which a judgment has not yet been made (S38), and if so, the process from step S31 is repeated for all QoS groups.

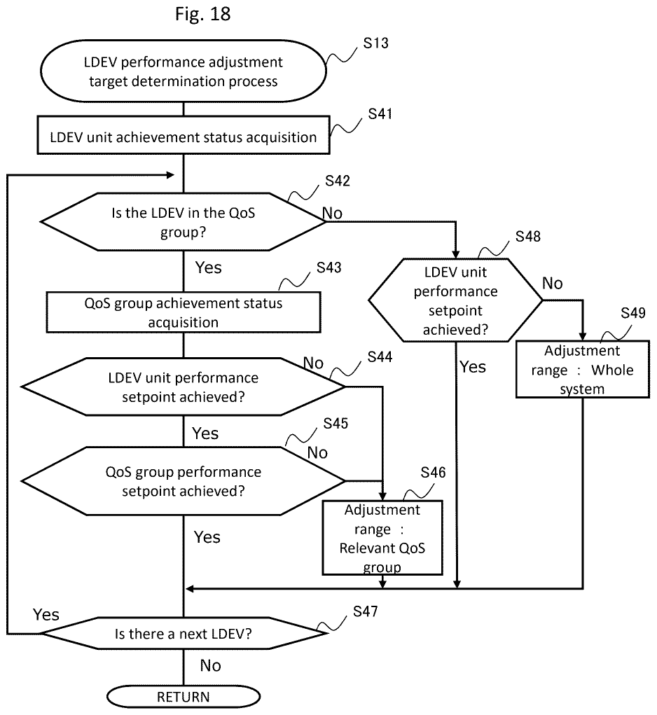

FIG. 18 shows an example of the flowchart of the LDEV performance adjustment target judgment process S13 in the embodiment. First, the adjustment range judgment section 35 refers to the achievement table 39 to obtain the target value achievement status of the LDEV unit (S41).

Next, the adjustment range judgment section 35 determines whether the LDEV in question is included in a QoS group by referring to the configuration information table 58 (S42), and if it is included in a QoS group, it refers to the achievement table 39 to obtain the target value achievement status of the QoS group (S43), determines whether the QoS settings (upper limit, lower limit and response target value) for each LDEV are achieved (S44), and if any of them are not achieved, sets the performance adjustment range to the relevant QoS group (S46).

If the QoS setting per LDEV is achieved in step S44, determine whether the QoS setting in the QoS group is achieved (S45), and if none of the QoS settings are achieved, the performance adjustment range is set to the relevant QoS group (S46).

If the QoS settings in the QoS group have been achieved in step S45, it is judged that no performance adjustment is required and it is determined whether there is an outstanding LDEV to be judged (S47). If there is another LDEV, the process returns to step S42.

If the LDEV to be judged is not included in the QoS group in step S42, it judges whether the QoS settings are achieved for each LDEV (S48), and if any of them are achieved, it moves to step S47 and moves to processing for the next LDEV. If not achieved in step S48, the performance adjustment range is set to the entire system (S49), then move to step S47 and process the next LDEV.

If the target is not achieved in step S44 and step S45, the performance adjustment range is set to the QoS group that includes the LDEV to be determined, and the process moves to step S47 for the next LDEV.

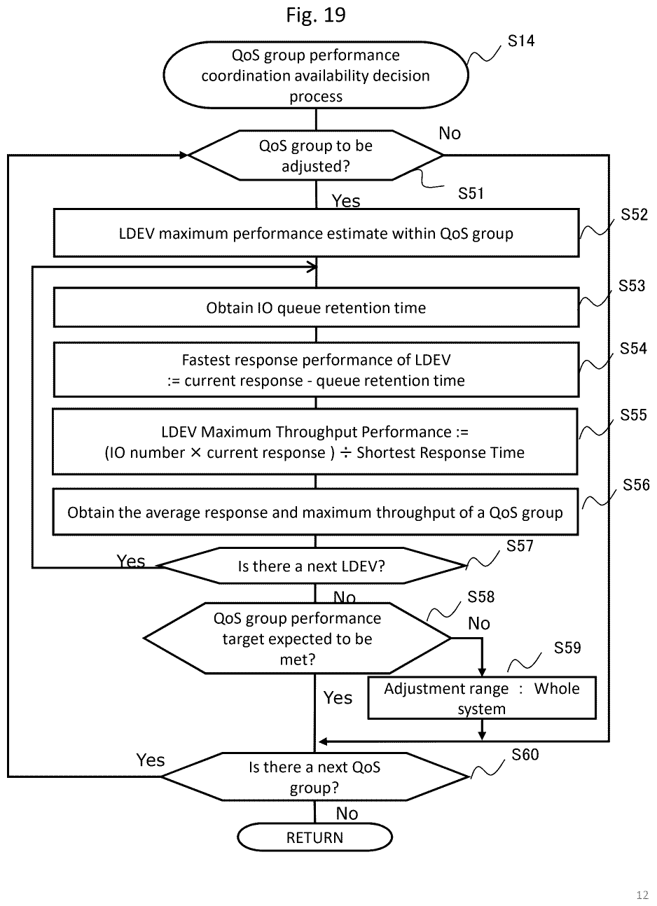

FIG. 19 shows an example flowchart of the S14 process for determining whether performance adjustment is possible within a QoS group in the embodiment. The specific process of determining whether to adjust performance within a QoS group shall be described below. First, the procedure for determining whether to adjust performance within a QoS group is explained using FIG. 19.

First, the adjustment range judgment section 35 determines whether the QoS group is subject to performance adjustment (S51), and if so, estimates the maximum performance of the LDEVs in that QoS group (S52).

Next, the retention time acquisition section 33 acquires the retention time of the IO queue for each LDEV in the QoS group subject to performance adjustment (S53), and the adjustment range judgment section 35 obtains fastest response performance of the LDEV by subtracting the retention time from the current response time (S54).

Then, adjustment range judgment section 35 obtains the total response time from the current number of IOs and the current number of responses, and obtains the LDEV maximum throughput performance, which is the maximum number of IOs processed divided by the total response time divided by the fastest response time (S55).

Furthermore, the average response and maximum throughput of the QoS group that can be expected based on the LDEV maximum throughput that was obtained (S56).

The adjustment range judgment section 35 then determines whether there is another LDEV in the QoS group (S57), and if so, returns to the process in step S53. If there is no next LDEV, it determines whether the QoS group performance target is expected to be achieved (S58).

In step S58, the adjustment range judgment section 35 compares the QoS setting stored in the QoS group configuration information (see FIG. 5) with the expected average response of the obtained QoS group and the maximum throughput to determine whether the target, determine whether it is likely to be achieved performance target by performing a target achievability evaluation.

If there is a possibility of achieving the target in step S58, the adjustment range judgment section 35 determines whether there are other QoS groups (S60), and if so, it returns to step S51 and performs step S52~S57 for all QoS groups. If there is no possibility of achieving the goal in step S58, the adjustment range is set to the entire system (S59), and the process moves to step S60.

The following is an explanation of the method for determining whether the performance of LDEVs and QoS groups can be adjusted, using QoS group #1, which consists of three LDEVs (LDEVs #1-LDEV #3) as shown in the operation information table in FIG. 6, as an example.

First, find the maximum performance of LDEV within QoS group #1.

If the measured actual response of LDEV #1 is 12 μs and the retention time of the IO queue of LDEV #1 is 3 μs, the fastest response is 12 μs−3 μs=9 μs.

If LDEV #1 has 400 IO and the elapsed time is 0.5 s, the maximum throughput is =(400 IO/0.5 s×12 μs)÷9 μs=1066 IOPS.

If LDEV #1 had a unit time input/output of 1066 IOPS and 4 Mbyte of data transfer, the maximum data transfer rate would be 1066 IOPS×(4M÷400 IO)=10.66 MBPS.

If the same calculation is performed for LDEV #2-#3, the performance values for each LDEV are as follows.

### LDEV #1

Fastest response=12 μs−3 μs=9 μs

Maximum throughput=(400 IO/0.5 s×12 μs)÷9 μs=1066 IOPS

Maximum data transfer=1066 IOPS×(4M÷400 IO)=10.66 MBPS

### LDEV #2

Fastest response=15 μs−5 μs=10 μs

Maximum throughput=(100 IO/0.5 s×15 μs)÷10 μs=300 IOPS

Maximum data transfer rate=300 IOPS×(2M÷100 IO)=6 MBPS

### LDEV #3

Fastest response=5 μs−1 μs=4 μs

Maximum throughput=(1000 IO/0.5 s×5 μs)÷4 μs=2500 IOPS

Maximum data transfer=2500 IOPS×(10M÷1000 IO)=25 MBPS

From these values, the maximum performance of QoS group #1 is the sum of LDEV #1+LDEV #2+LDEV #3 and is as follows.

Average response=(9 μs*1066 IOPS+10 μs*300 IOPS+4 μs* 2500 IOPS)/(1066 IOPS+300 IOPS+2500 IOPS)=5.8 μs

Maximum throughput=1066 IOPS+300 IOPS°2500 IOPS=3866 IOPS

Maximum data transfer rate=10.66 MBPS+6 MBPS+25 MBPS=41.66 MBPS

Comparing the maximum performance obtained with the QoS settings for LDEV #1-LDEV #3 shown in FIG. 4, the target achievability evaluation is as follows.

LDEV #1: 1066 IOPS<1200 IOPS->LDEV upper limit setting achievable

LDEV #2: 6 MBPS>5 MBPS->LDEV lower limit setting achievable

LDEV #3: 4 μs<1 ms->Target response achievable

Comparing the maximum performance obtained with the QoS settings for QoS group #1 shown in FIG. 5, the target achievability evaluation for QoS group #1 is as follows.

QoS group #1: 3866 IOPS<5000 IOPS->QoS group upper limit achievable.

Therefore, QoS group #1 is determined to be adjustable in the QoS group.

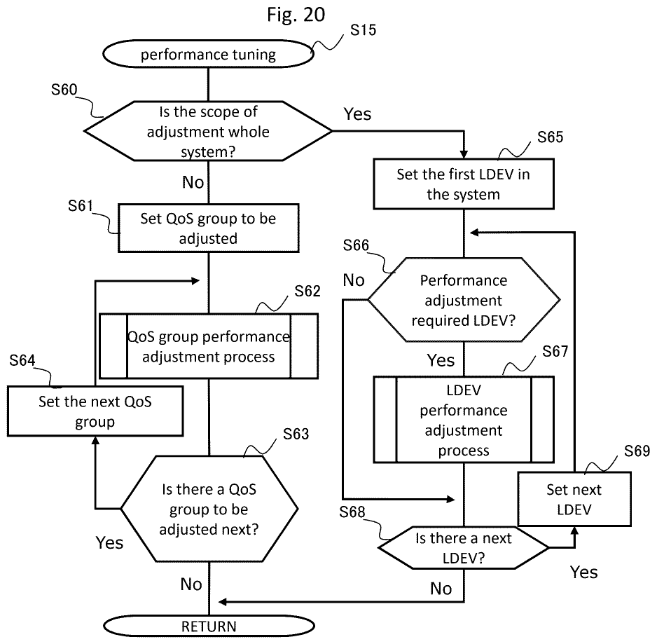

FIG. 20 shows an example flowchart of the performance adjustment process S15 in the embodiment.

Through the LDEV performance adjustment target judgment process S13 and QoS group performance adjustment availability judgment process S14, the availability of performance adjustment is judged for each LDEV and QoS group in storage device 1, and whether the target range of performance adjustment is the QoS group or the entire system is determined. The range of the performance adjustment is determined whether it is for a QoS group or the entire system.

If there is even one QoS group that cannot be adjusted, the entire system must be adjusted. LDEVs for which no performance settings have been made are not subject to the performance adjustment process, since there is no need to adjust their performance.

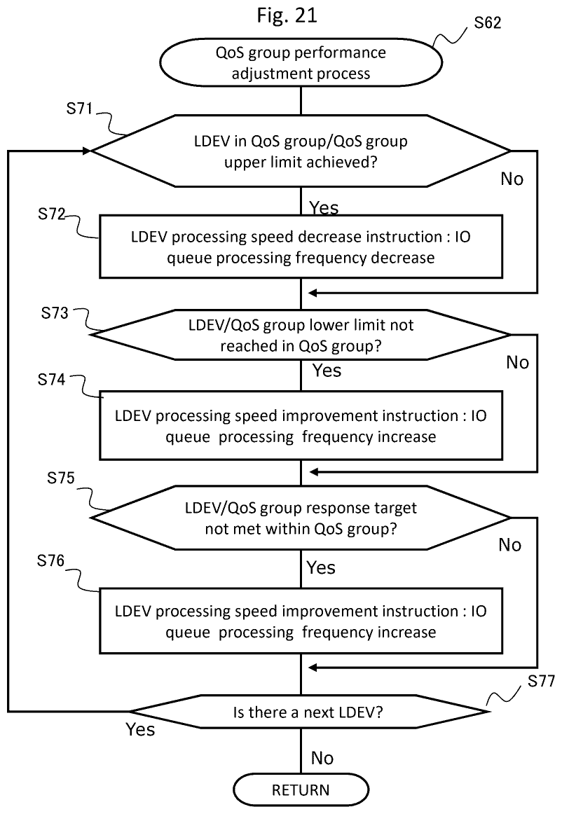

First, performance control section 34 determines whether the performance adjustment range is entire system (S60), and if it is not entire system (No in S60), the performance of the QoS group is adjusted. The QoS group to be adjusted is set as the processing target (S61), and the QoS group performance adjustment process (S62) is performed. The details of step S62 are described below using FIG. 21.

Since the performance adjustment of a QoS group only needs to be performed for those QoS groups that do not meet the required performance and are determined to require performance adjustment, the QoS groups that meet the performance requirements are not processed.

After completion of step S62, the performance control section 34 determines whether there are other QoS groups to be adjusted (S63), and if so, sets the next QoS group (S64) and returns to step S62. If not, the process ends.

If the adjustment range is determined to be the entire system in step S60 (Yes in S60), the performance control section 34 sets one LDEV in the system as the target for processing (S65) to adjust the performance of each LDEV and determines whether the LDEV requires performance adjustment (S66).

If it is an LDEV that needs performance adjustment (Yes in S66), performance control section 34 performs the performance adjustment process (S67) for LDEV5. The details of step S67 are described below using FIG. 22.

After completion of step S67, or if the LDEV does not require performance adjustment in step S66 (No in S66), the performance control section 34 determines if there are any unset LDEVs in the system (S68). If there is a next LDEV, it is set for processing and returns to step S66. If there is none, the process ends.

The QoS group-based performance adjustment process is less burdensome for the storage system because it adjusts the performance of LDEVs belonging to a QoS group when the QoS group does not meet performance requirements and when the QoS group can be adjusted within the QoS group.

On the other hand, entire system tuning is performed for all LDEVs in the storage system, so the load on the storage system is high.

FIG. 21 shows an example of the flowchart of the S62 QoS group performance adjustment process in the embodiment. For each LDEV in the QoS group to be adjusted, the performance control section 34 determines whether the maximum number of IOs or data transfer rate (see FIG. 4 and FIG. 5) of the respective QoS settings of that LDEV and the QoS group to be adjusted(hereinafter referred to as “LDEV/QoS group in QoS group” in the description of FIG. 21) is exceeded (S71). If either of the upper limits is exceeded in step S71 (Yes in S71), the performance control section 34 performs the processing speed reduction of LDEV 5 belonging to the QoS group (S72). Specifically, the frequency of IO queue processing (polling), which is the frequency of executing input/output processing requests to the target LDEV 5 is reduced. The IO activation section 45 activates the input/output requests registered in IO queue 4 to LDEV 5 at the set IO queue 4 processing frequency.

After performing step S72 or if the value is less than or equal to any of the limits in step S71 (No in S71), the performance control section 34 determines whether the lower limit (see FIG. 4 and FIG. 5) for the number of IOs or data transfer of the respective QoS setting of the LDEV/QoS group in the QoS group has not been reached (S73). If either of the lower limits has not been reached (Yes in S73), the performance control section 34 executes the processing speed improvement of LDEV 5 belonging to the QoS group (S74). Specifically, the IO queue processing frequency, which is the frequency of IO processing execution requests to LDEV 5, is increased. The IO activation section 45 activates the input/output requests registered in IO queue 4 to LDEV 5 at the processing frequency of IO queue 4 that has been set.

After executing step S74 or if the lower limit is exceeded in step S73 (No in S73), the performance control section 34 determines whether the response target (see FIG. 4 and FIG. 5) of the LDEV/QoS group in the QoS group has not been reached (S75). If it has not been reached (Yes in S75), the processing speed improvement of LDEV5 belonging to the QoS group is executed (S76). Specifically, the frequency of IO queue processing, which is the frequency of IO processing execution requests to the LDEVs in the QoS group, is increased. The IO activation section 45 activates the input/output requests registered in IO queue 4 to LDEV5 at the processing frequency of IO queue 4 that has been set.

After executing step S76 or if the target value is exceeded in step S75 (No in S75), performance control section 34 determines whether there are other LDEVs in the target QoS group (S77), and if so, repeats the process from step S71 for all LDEVs. If not, the process ends.

FIG. 22 shows an example of the flowchart of the LDEV performance adjustment process S67 in the embodiment. For each LDEV5 in storage device 52, the performance control section 34 determines whether the upper limit of the number of IOs or the amount of data transfer (see FIG. 4 and FIG. 5) of the respective QoS settings of the target LDEV and the QoS group to which the LDEV belongs(Hereafter referred to as “LDEV/QoS group” in the description of FIG. 22) is exceeded (S80). If either of the upper limits is exceeded (Yes in S80), the processing speed of the target LDEV is reduced (S81). Specifically, the frequency of IO queue processing, which is the frequency of IO processing execution requests to the target LDEV, is lowered. The IO activation section 45 activates the input/output requests registered in IO queue 4 to LDEV5 at the processing frequency of IO queue 4 that has been set.

After execution of step S81 or if either of the upper limits is less than or equal to the upper limit in step S80 (No. in S80), performance control section 34 checks whether the lower limit of either the number of IOs or the amount of data transfer in the respective QoS settings of the LDEV/QoS group (see FIG. 4 and FIG. 5). If not (Yes in S82), the processing speed of the target LDEV is improved (S83). Specifically, the frequency of IO queue processing, which is the frequency of IO processing execution requests to the LDEV, is increased. The IO activation section 45 activates the input/output requests registered in IO queue 4 to LDEV 5 at the processing frequency of IO queue 4 that has been set.

After executing step S83 or if any of the lower limits are exceeded in step S82 (No in S82) the performance control section 34 determines whether the response target (see FIG. 4 and FIG. 5) of the LDEV/QoS group has not been reached (S84), and if it has If not (Yes in S84), the processing speed of the target LDEV is improved (S85). Specifically, the frequency of IO queue processing, which is the frequency of IO processing execution requests to LDEV 5, is increased. The IO activation section 45 activates the input/output requests registered in IO queue 4 to LDEV 5 at the processing frequency of IO queue 4 that has been set.

After execution of step S85 or if the target value is exceeded in step S84 (No in S84), the process ends.

In summary, this embodiment enables flexible resource management according to individual needs while maintaining a high level of overall service quality. This technology is essential for continuing to provide competitive storage services and is an approach that enables service provision in line with user needs.

The processes described here are for ease of understanding of the invention. Necessary processes may be added or deleted based on the type, configuration, use, and characteristics of the storage system. Therefore, the present invention need not include all the processes described here and is not limited to the embodiments.

### REFERENCE SIGNS LIST

1 Storage device
2 Controller (CTL)
3 QoS group
4 IO queue
5 Logical volume (LDEV)
10 Shared memory between CTL
30 Business server
33 Retention time acquisition section
34 Performance control section
35 Adjustment range judgment section
36 Operation information acquisition section
37 Shared memory in CTL
39 Achievement table
40 IO queue retention time table
41 Operation information table
42 Achievement aggregation section
43 Input section
44 Management server
45 IO activation section
50 Memory
51 Microprocessor (MP)
54 Shared memory in CTL
57 QoS achievement table
58 Configuration information table

1. A storage system including a plurality of logical volumes and one or more logical volume groups each containing at least one of the pluralities of logical volumes comprising:
a memory storing QoS settings, which are the required performance values for the logical volumes or logical volume groups, set for each logical volume and each logical volume group,
an adjustment range judgement section determines the adjustment range of the logical volume by adjust the processing speed of IO requests to the logical volumes in the logical volume group or adjust the processing speed of IO requests to the logical volumes in the entire system when the QoS setting of the logical volume is not satisfied or the QoS setting of the logical volume group is not satisfied, and
a performance control section judging whether the performance setting value for the logical volume in the adjustment range is satisfied and adjusting the processing speed of input/output requests to the logical volume in the adjustment range based on the judgment result.

2. The storage system according to claim 1, wherein
the QoS settings including at least one type of performance setting value,
the adjustment range judgment section is configured to determine adjust the processing speed of input/output request to the logical volume for the entire storage system when the logical volume is not included in the logical volume group and all the QoS setting for the logical volume is not met with the specified QoS setting, and
to determine adjust the processing speed of input/output request to the logical volume belong to the logical volume group when the logical volume is in the logical volume group, and the performance of the logical volume is not satisfied the specified all the QoS settings for the logical volume and the performance of the logical volume group is not satisfied the specified all the QoS settings for the logical volume group.

3. The storage system according to claim 2,
wherein the type of the QoS settings includes at least the number of IO per unit time and the amount of data transferred per unit time.

4. The storage system according to claim 3, further comprising:
a retention time acquisition section for acquiring a retention time of an IO request registered in an IO queue corresponding to each logical volume,
wherein the performance control section determines whether it is possible to satisfy the specified QoS settings for the logical volume and the logical volume group based on the retention time acquired by the retention time acquisition section for the logical volume and logical volume group, when determined the performance setting value does not meet with the specified performance setting value adjust the processing speed of IO requests to the logical volume of the entire storage.

5. The storage system according to claim 2, further comprising:
an IO activation section for activating the IO requests registered in the IO queue corresponding to each logical volume at a time interval specified by the performance control section,
wherein when controlling the processing speed of the IO requests to the logical volume,
the performance control section instructs the IO processing interval shorten to increase the processing speed of the IO requests,
the performance control section instructs the IO processing interval lengthen to reduce the processing speed of the IO requests.

6. The storage system according to claim 3 further comprising:
an operation information acquisition section for acquiring operation information of the logical volume and the logical volume group,
wherein for the logical volume and logical volume group determined in an adjustment range by the adjustment range judgement section,
the performance control section refers to the QoS settings and corresponding to operation information of the logical volume and logical volume group in the adjustment range, and
determine whether the operation information is conforming to each QoS settings,
when one of the operating information is reaching the upper limit of the QoS settings, instruct reduce the processing speed of IO request to the logical volume for adjustment.

7. The storage system according to claim 3 further comprising:
an operation information acquisition section for acquiring operation information of the logical volume and the logical volume group,
wherein for the logical volume and logical volume group determined in an adjustment range by the adjustment range judgement section,
the performance control section refers to the QoS settings and corresponding to operation information of the logical volume and logical volume group in the adjustment range, and
determine whether the operation information is conforming to each QoS settings,
when one of the operating information is reaching the lower limit of the QoS settings, instruct increase the processing speed of IO request to the logical volume for adjustment.

8. The storage system as recited in claim 3 further comprising:
an operation information acquisition section for acquiring operation information of the logical volume and the logical volume group,
wherein for the logical volume and logical volume group determined in an adjustment range by the adjustment range judgement section,
the performance control section refers to the QoS settings and corresponding to operation information of the logical volume and logical volume group in the adjustment range, and
determine whether the operation information is conforming to each QoS settings,
when one of the operating information is not reaching the response time target of the QoS settings, instruct increase the processing speed of IO request to the logical volume for adjustment.

9. The storage system according to claim 3 further comprising:
an operation information acquisition section for acquiring operation information of the logical volume and the logical volume group,
wherein for the logical volume of the entire storage system determined in an adjustment range by the adjustment range judgement section,
the performance control section refers to the QoS settings and corresponding to operation information of the logical volume and logical volume group in the adjustment range, and
determine whether the operation information is conforming to each QoS settings,
when one of the operating information is reaching the upper limit of the performance setting value, instruct reduce the processing speed of IO request to the logical volume for adjustment.

10. The storage system according to claim 3 further comprising:
an operation information acquisition section for acquiring operation information of the logical volume and the logical volume group,
wherein for the logical volume of the entire storage system determined in an adjustment range by the adjustment range judgement section,
the performance control section refers to the QoS settings and corresponding to operation information of the logical volume and logical volume group in the adjustment range, and
determine whether the operation information is conforming to each QoS settings,
when one of the operating information is reaching the lower limit of the performance setting value, instruct increase the processing speed of IO request to the logical volume for adjustment.

11. The storage system according to claim 3 further comprising:
an operation information acquisition section for acquiring operation information of the logical volume and the logical volume group,
wherein for the logical volume of the entire storage system determined in an adjustment range by the adjustment range judgement section,
the performance control section refers to the QoS settings and corresponding to operation information of the logical volume and logical volume group in the adjustment range, and
determine whether the operation information is conforming to each QoS settings,
when one of the operating information is reaching the response time target of the performance setting value, instruct increase the processing speed of IO request to the logical volume for adjustment.

12. A storage system control method comprising:
plurality of logical volumes and one or more logical volume groups each containing at least one of said plurality of logical volumes,
storing QoS settings, which are the required QoS settings for the logical volume or logical volume group in a memory,
determining adjusting the processing speed of input/output requests to the logical volume in the logical volume group when the logical volume is in the logical volume group and the performance setting value of the logical volume is not satisfied or the QoS settings of the logical volume group is not satisfied,
determining adjust the processing speed of input/output requests to the logical volume in the storage entire system when the logical volume is not in the logical volume group and the QoS settings of the logical volume is not satisfied or the QoS settings of the logical volume group is not satisfied, and
judging whether the QoS settings satisfying for the logical volume within the adjustment range, adjusting the processing speed of input/output requests to the logical volume within the adjustment range based on the judgment result.
